(19) United States
(12) Patent Application Publication
(10) Pub. No.: US 2021/0094567 A1
(43) Pub. Date: Apr. 1, 2021

(54) REMOTE MONITORING APPARATUS AND ASSISTANCE METHOD FOR AUTONOMOUS VEHICLE

(71) Applicant: DENSO CORPORATION, Kariya-city (JP)

(72) Inventors: Kenichirou IMAI, Kariya-city (JP); Toru NAGURA, Kariya-city (JP); Takuya MORI, Kariya-city (JP); Satoshi YOSHINAGA, Kariya-city (JP)

(21) Appl. No.: 17/034,363

(22) Filed: Sep. 28, 2020

(30) Foreign Application Priority Data
Sep. 30, 2019 (JP) 2019-178511

(51) Int. Cl. B60W 60/00; G05D 1/00; B60W 50/14

(52) U.S. Cl. CPC B60W 60/005; G05D 1/0038; B60W 2420/42; B60W 60/001; B60W 2556/45; B60W 50/14

(57) ABSTRACT

A remote monitoring apparatus includes an assistance request receiving unit, an object information receiving unit, a determining unit, a past image receiving unit and an operator collaboration unit. The assistance request receiving unit receives an assistance request transmitted from an autonomous vehicle. The object information receiving unit requests, before the assistance request is sent to an operator, the autonomous vehicle to transmit object information and receives it from the autonomous vehicle. The determining unit determines, based on the object information, whether at least one past image is required. The past image receiving unit requests, upon determination by the determining unit that at least one past image is required, the autonomous vehicle to transmit the at least one past image and receives it from the autonomous vehicle. The operator collaboration unit sends the at least one past image along with the assistance request to the operator.

### CROSS-REFERENCE TO RELATED APPLICATION

This application is based on and claims priority from Japanese Patent Application No. 2019-178511 filed on Sep. 30, 2019, the contents of which are hereby incorporated by reference in their entirety into this application.

### BACKGROUND

### 1 Technical Field

The present disclosure relates to remote monitoring apparatuses and assistance methods for autonomous vehicles.

### 2 Description of Related Art

There is known a remote monitoring technique for securing the safety of an autonomous vehicle during autonomous traveling thereof. According to the remote monitoring technique, the autonomous vehicle automatically stops upon detection of an obstacle based on information acquired from autonomous sensors including a camera. Moreover, the autonomous vehicle transmits images of surroundings of the vehicle, which are captured by the camera, to a remote monitoring center. Based on the images received from the autonomous vehicle, the remote monitoring center determines whether traveling of the autonomous vehicle that is in the stopped state can be restarted. With this technique, it is possible for an operator of the remote monitoring center to supplement the detecting performance of the sensors of the autonomous vehicle, thereby securing the safety of the autonomous vehicle.

### SUMMARY

According to the present disclosure, there is provided a remote monitoring apparatus for monitoring an autonomous vehicle via remote communication with the autonomous vehicle. The remote monitoring apparatus includes an assistance request receiving unit, an object information receiving unit, a determining unit, a past image receiving unit and an operator collaboration unit. The assistance request receiving unit is configured to receive an assistance request transmitted from the autonomous vehicle. The object information receiving unit is configured to request, before the assistance request received by the assistance request receiving unit is sent to an operator, the autonomous vehicle to transmit object information on an object in the vicinity of the autonomous vehicle and receive the object information transmitted from the autonomous vehicle. The determining unit is configured to determine, based on the object information received by the object information receiving unit, whether at least one past image captured by the autonomous vehicle is required. The past image receiving unit is configured to request, in response to determination by the determining unit that at least one past image captured by the autonomous vehicle is required, the autonomous vehicle to transmit the at least one past image and receive the at least one past image transmitted from the autonomous vehicle. The operator collaboration unit is configured to send, in response to receipt of the at least one past image by the past image receiving unit, the at least one past image along with the assistance request received by the assistance request receiving unit to the operator, thereby initiating collaboration with the operator.

According to the present disclosure, there is also provided a method of assisting an autonomous vehicle in a remote monitoring system. The remote monitoring system includes the autonomous vehicle and a remote monitoring apparatus configured to monitor the autonomous vehicle via remote communication with the autonomous vehicle. The assistance method includes an assistance request transmitting step, an object information request transmitting step, an object information transmitting step, a determining step, a past image request transmitting step, a past image transmitting step and an assistance request notifying step. In the assistance request transmitting step, the autonomous vehicle transmits an assistance request to the remote monitoring apparatus. In the object information request transmitting step, the remote monitoring apparatus transmits, upon receipt of the assistance request transmitted from the autonomous vehicle, an object information request to the autonomous vehicle. In the object information transmitting step, the autonomous vehicle transmits, in response to the object information request from the remote monitoring apparatus, object information to the remote monitoring apparatus. The object information is information on an object in the vicinity of the autonomous vehicle. In the determining step, the remote monitoring apparatus determines, based on the object information transmitted from the autonomous vehicle, whether at least one past image captured by the autonomous vehicle is required. In the past image request transmitting step, the remote monitoring apparatus transmits, upon determining that at least one past image captured by the autonomous vehicle is required, a past image request to the autonomous vehicle. In the past image transmitting step, the autonomous vehicle transmits, in response to the past image request from the remote monitoring apparatus, at least one past image captured by the autonomous vehicle to the remote monitoring apparatus. In the assistance request notifying step, the remote monitoring apparatus notifies an operator of the assistance request from the autonomous vehicle. Moreover, in the assistance method, upon receipt of the at least one past image transmitted from the autonomous vehicle, the remote monitoring apparatus sends, in the assistance request notifying step, the at least one past image along with the assistance request to the operator.

### BRIEF DESCRIPTION OF THE DRAWINGS

FIG. 1 is a schematic diagram illustrating the overall configuration of a remote monitoring system according to a first embodiment.

FIG. 2A is an explanatory diagram illustrating a first example where past images are required.

FIG. 2B is an explanatory diagram illustrating a second example where past images are required.

FIG. 3 is an explanatory diagram illustrating a third example where past images are required.

FIG. 4 is a flowchart illustrating operation of the remote monitoring system according to the first embodiment.

FIG. 5 is a flowchart illustrating operation of a remote monitoring system according to a second embodiment.

### DESCRIPTION OF EMBODIMENTS

The inventors of the present application have found, through investigation, that the above-described remote monitoring technique known in the art (see, for example, Japanese Patent Application Publication No. JP 2019-087015 A) may involve the following problems.

That is, an autonomous vehicle, which has fallen into a situation where it is difficult for the autonomous vehicle to continue traveling (e.g., has been in a stopped state for a given length of time or longer), transmits an assistance request to the remote monitoring center. However, it may be difficult for an operator of the remote monitoring center to provide, upon receipt of the assistance request, suitable assistance to the autonomous vehicle based only on the real-time images transmitted from the autonomous vehicle.

Otherwise, it may be possible for the autonomous vehicle to transmit, along with the assistance request, past images captured by the autonomous vehicle to the remote monitoring center, thereby enabling an operator of the remote monitoring center to provide suitable assistance to the autonomous vehicle based on both the real-time images and the past images. However, in this case, the communications traffic would be increased.

In contrast, with the above-described remote monitoring apparatus and assistance method according to the present disclosure, it is possible to: determine, before the assistance request transmitted from the autonomous vehicle is sent to an operator, whether at least one past image captured by the autonomous vehicle is required; and request, only when it is determined that at least one past image captured by the autonomous vehicle is required, the autonomous vehicle to transmit the at least one past image to the remote monitoring apparatus. Consequently, it is possible to provide suitable assistance to the autonomous vehicle while suppressing the communications traffic.

Exemplary embodiments will be described hereinafter with reference to the drawings. It should be noted that for the sake of clarity and understanding, identical components having identical functions throughout the whole description have been marked, where possible, with the same reference numerals in the drawings and that for the sake of avoiding redundancy, descriptions of identical components will not be repeated.

### First Embodiment

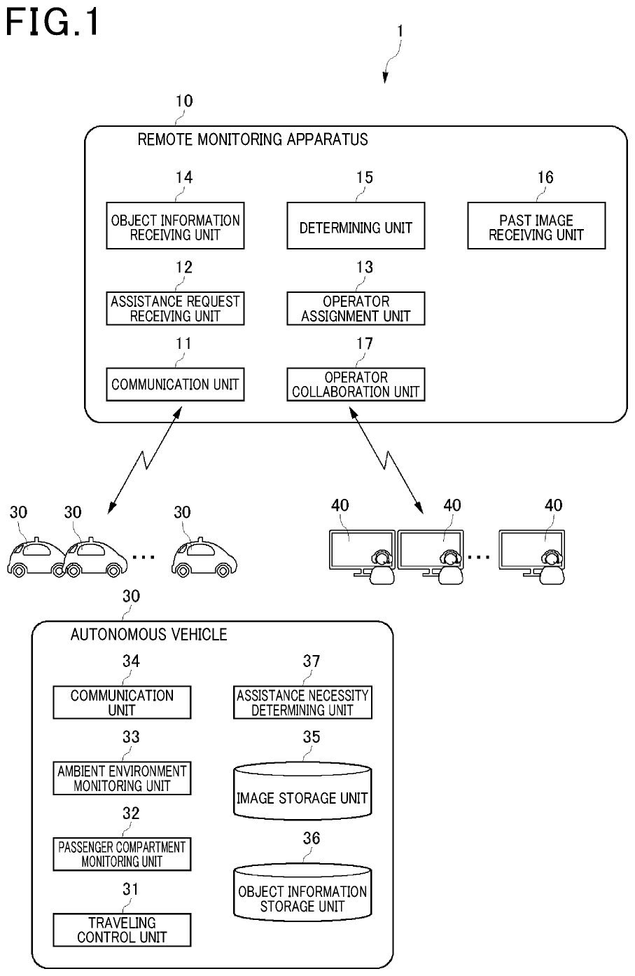

FIG. 1 shows the overall configuration of a remote monitoring system 1 according to the first embodiment.

As shown in FIG. 1, the remote monitoring system 1 includes a remote monitoring apparatus 10 and a plurality of autonomous vehicles 30 configured to communicate with the remote monitoring apparatus 10 via a network. That is, the remote monitoring apparatus 10 monitors the autonomous vehicles 30 via remote communication with them.

The remote monitoring apparatus 10 is connected with a plurality of operator terminals 40 that are operated by respective operators. When any of the autonomous vehicles 30 requires assistance, the remote monitoring apparatus 10 sends data pertaining to the autonomous vehicle 30 to one of the operator terminals 40, thereby collaborating with the operator who operates the operator terminal 40. More specifically, upon receipt of an assistance request from any of the autonomous vehicles 30, the remote monitoring apparatus 10 assigns the assistance request to one of the operators who can handle the assistance request, thereby initiating collaboration with the operator.

The remote monitoring apparatus 10 includes a communication unit 11, an assistance request receiving unit 12, an operator assignment unit 13, an object information receiving unit 14, a determining unit 15, a past image receiving unit 16 and an operator collaboration unit 17.

The communication unit 11 is configured to perform remote communication with the autonomous vehicles 30. With the communication unit 11, various data exchange is realized between the remote monitoring apparatus 10 and the autonomous vehicles 30.

The assistance request receiving unit 12 is configured to receive assistance requests transmitted from the autonomous vehicles 30. In addition, each of the autonomous vehicles 30 is configured to transmit an assistance request to the remote monitoring apparatus 10 when the autonomous vehicle 30 has fallen into a situation where it is difficult for the autonomous vehicle 30 to continue traveling (e.g., has been in a stopped state for a given length of time or longer).

The operator assignment unit 13 is configured to assign, for each of the assistance requests transmitted from the autonomous vehicles 30, one of the operators to handle the assistance request. The operator assignment unit 13 may assign the assistance requests to the operators in the order that the assistance requests are received by the assistance request receiving unit 12. Otherwise, in the case of the assistance requests having priority data, the operator assignment unit 13 may sequentially assign the assistance requests to the operators according to the priority data from that one of the assistance requests which has the highest priority. In addition, when there is no operator available for handling an assistance request, the operator assignment unit 13 places the assistance request in an assistance request queue.

In the present embodiment, the remote monitoring apparatus 10 collects, before sending a notice of an assistance request to the operator terminal 40 of the operator who is assigned to handle the assistance request (or before starting collaboration with the operator), information necessary for the operator to determine the current situation of the autonomous vehicle 30 which has transmitted the assistance request.

Upon the assignment of an assistance request to one of the operators by the operator assignment unit 13, the object information receiving unit 14 receives object information from the autonomous vehicle 30 which has transmitted the assistance request. In addition, at this stage, the assistance request has not been sent to the operator terminal 40 of the operator who is assigned to handle the assistance request. That is, the object information receiving unit 14 receives the object information before the assistance request is sent to the operator terminal 40.

The object information includes, for example, the positions of objects in the vicinity of the autonomous vehicle 30, the times at which the objects were first recognized by the autonomous vehicle 30, the statuses (e.g., moving/stopped) of the objects, the speeds of the objects, the directions of movements of the objects, the widths and heights of the objects, and the types of the objects (e.g., a pedestrian, a vehicle or a motorcycle).

More specifically, in the present embodiment, the object information receiving unit 14 transmits an object information request to the autonomous vehicle 30 which has transmitted the assistance request. Upon receipt of the object information request, the autonomous vehicle 30 transmits the object information to the remote monitoring apparatus 10. Then, the object information receiving unit 14 receives the object information transmitted from the autonomous vehicle 30.

The determining unit 15 is configured to determine, based on the object information transmitted from the autonomous vehicle 30, whether past images captured by the autonomous vehicle 30 (hereinafter, to be simply referred to as past images) is required for determination of the current situation of the autonomous vehicle 30. For example, when there is no moving object in the vicinity of the autonomous vehicle 30 and/or there is no traffic participant in the vicinity of the autonomous vehicle 30, the determining unit 15 determines that past images are required for determination of the current situation of the autonomous vehicle 30.

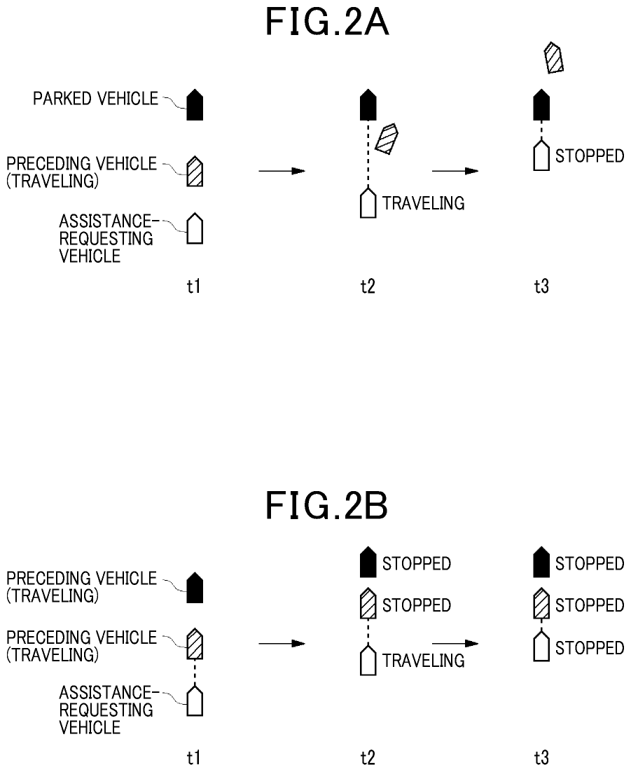

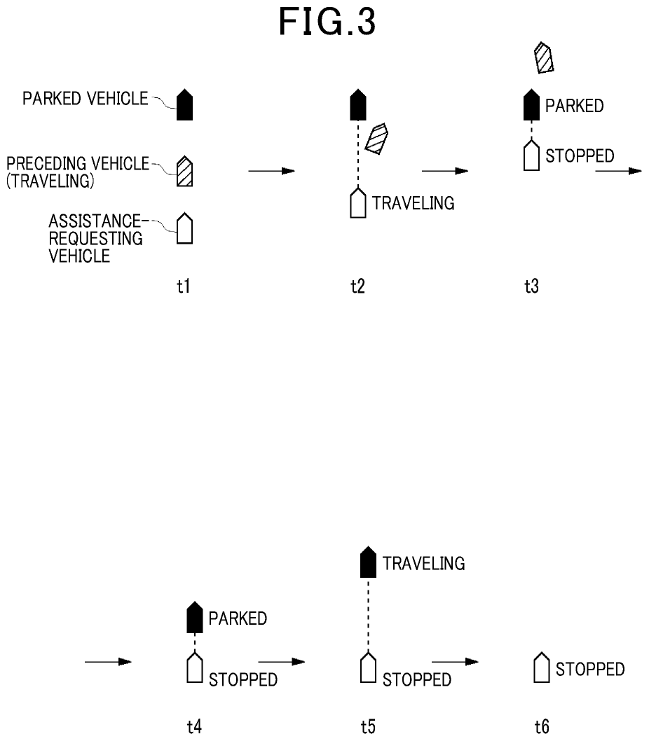

FIGS. 2A-2B and 3 respectively illustrate three examples where it is impossible to determine the current situation of the autonomous vehicle 30, which has transmitted the assistance request, based only on the real-time images captured by the autonomous vehicle 30 (hereinafter, to be simply referred to as the real-time images). It should be noted that in the following explanation and in FIGS. 2A-2B and 3, the term “assistance-requesting vehicle” denotes the autonomous vehicle 30 which has transmitted the assistance request.

First, referring to FIG. 2A, explanation will be given of a first example where it is impossible to determine the current situation of the assistance-requesting vehicle based only on the real-time images. In this example, at a time instant t1, a preceding vehicle travels ahead of the assistance-requesting vehicle and there is a parked vehicle in front of the preceding vehicle. Then, at a time instant t2, the preceding vehicle passes the parked vehicle. Thereafter, at a time instant t3, the assistance-requesting vehicle stops due to the parked vehicle present in front of it.

Next, referring to FIG. 2B, explanation will be given of a second example where it is impossible to determine the current situation of the assistance-requesting vehicle based only on the real-time images. In this example, at a time instant t1, a first preceding vehicle travels ahead of a second preceding vehicle and the second preceding vehicle travels ahead of the assistance-requesting vehicle. That is, the three vehicles travel in tandem with each other. At a time instant t2, the first preceding vehicle stops and then the second preceding vehicle stops. Thereafter, at a time instant t3, the assistance-requesting vehicle also stops due to the preceding vehicles stopped in front of it.

Comparing the first example shown in FIG. 2A and the second example shown in FIG. 2B, the assistance-requesting vehicle is caused to stop by the parked vehicle present in front of it in the first example whereas the assistance-requesting vehicle is caused to stop by the preceding vehicles stopped in front of it in the second example. However, in both the examples, based on the real-time images captured at the time instant t3, the current situation of the assistance-requesting vehicle can be determined only as having another vehicle stopped in front of it. That is, it is impossible to determine whether the vehicle in front of the assistance-requesting vehicle is in the stopped state for waiting a traffic light or in a traffic jam, or parked on the street. Consequently, it is impossible for the operator, who is assigned to handle the assistance request, to provide suitable assistance to the assistance-requesting vehicle.

Next, referring to FIG. 3, explanation will be given of a third example where it is impossible to determine the current situation of the assistance-requesting vehicle based only on the real-time images. It should be noted that the situation of the assistance-requesting vehicle at time instants t1-t3 in the third example shown in FIG. 3 is identical to that at the time instants t1-t3 in the first example shown in FIG. 2A.

In the third example shown in FIG. 3, at a time instant t4, the assistance-requesting vehicle is in the stopped state with the parked vehicle present in front of it. At a time instant t5, the parked vehicle starts traveling. Consequently, at a time instant t6, there is no vehicle present in front of the assistance-requesting vehicle that is kept in the stopped state. Therefore, it is impossible for the operator to determine, based only on the real-time images captured at the time instant t6, why the assistance-requesting vehicle is in the stopped state. However, it is necessary for the operator, who is assigned to handle the assistance request, to find what caused the assistance-requesting vehicle to be in the stopped state and check the safety of the assistance-requesting vehicle. That is, it is inappropriate for the operator to instruct the assistance-requesting vehicle to restart traveling just because there is currently no vehicle present in front of the assistance-requesting vehicle.

In addition, though not shown in the figures, in another example where the assistance-requesting vehicle is caused by a pedestrian to be in a stopped state, it is necessary for the operator to determine whether the pedestrian has walked away or has entered a blind spot of the assistance-requesting vehicle (i.e., whether there remains the risk of accidents). However, it is impossible for the operator to make the determination based only on the real-time images.

To sum up, in the above-described examples, past images are required for determination of the current situation of the autonomous vehicle 30.

The determining unit 15 is configured to set, upon determining that past images are required, a capturing time during which the required past images have been successively captured. More particularly, in the present embodiment, the determining unit 15 is configured to set the capturing time based on the object information. Specifically, in the first and second examples shown in FIGS. 2A and 2B, the capturing time may be set as a time period from when the preceding vehicle in front of the assistance-requesting vehicle was first recognized by the assistance-requesting vehicle to the present time. On the other hand, in cases where the object that caused the assistance-requesting vehicle to be in the stopped state is no longer present in front of the assistance-requesting vehicle (e.g., as in the third example shown in FIG. 3), the capturing time may be set as a time period of a given length (e.g., two minutes) up to the present time.

The past image receiving unit 16 is configured to receive, when it is determined by the determining unit 15 that past images are required, the past images captured by the assistance-requesting vehicle. More specifically, upon determination by the determining unit 15 that past images are required, the past image receiving unit 16 transmits a past image request to the assistance-requesting vehicle. Upon receipt of the past image request, the assistance-requesting vehicle transmits the required past images to the remote monitoring apparatus 10. Then, the past image receiving unit 16 receives the required past images transmitted from the assistance-requesting vehicle.

The operator collaboration unit 17 is configured to send, after the assignment of an assistance request to one of the operators by the operator assignment unit 13, the assistance request to the operator terminal 40 of the operator who is assigned to handle the assistance request, thereby initiating collaboration with the operator. Moreover, when it is determined by the determining unit 15 that past images are required and thus the required past images transmitted from the assistance-requesting vehicle are received by the past image receiving unit 16, the operator collaboration unit 17 sends the required past images along with the assistance request to the operator terminal 40 of the operator.

Each of the autonomous vehicles 30 includes a traveling control unit 31, a passenger compartment monitoring unit 32, an ambient environment monitoring unit 33, a communication unit 34, an image storage unit 35, an object information storage unit 36 and an assistance necessity determining unit 37.

The traveling control unit 31 is configured to control traveling (or driving) of the autonomous vehicle 30. More specifically, the traveling control unit 31 is configured to control a throttle, a brake and a steering device of the autonomous vehicle 30.

The passenger compartment monitoring unit 32 is configured to monitor the state inside a passenger compartment of the autonomous vehicle 30; the state inside the passenger compartment includes, for example, the state of a driver and/or the state of an occupant. The passenger compartment monitoring unit 32 includes, for example, a camera configured to capture images inside the passenger compartment and seat occupant sensors.

The ambient environment monitoring unit 33 is configured to monitor the state of the ambient environment of the autonomous vehicle 30. The ambient environment monitoring unit 33 includes, for example, a camera, a LIDAR, a millimeter-wave radar and an ultrasonic-wave radar.

The communication unit 34 is configured to perform remote communication with the remote monitoring apparatus 10. The communication unit 34 includes, for example, an onboard communication device and antennas. In addition, the communication unit 34 may be configured to communicate also with infrastructure and/or other vehicles.

The image storage unit 35 is configured to store therein images captured by the camera of the ambient environment monitoring unit 33 for a predetermined period of time (e.g., about 30 minutes).

The object information storage unit 36 is configured to store the object information therein. As described above, the object information includes, for example, the positions of objects detected by the ambient environment monitoring unit 33, the times at which the objects were first recognized by the ambient environment monitoring unit 33, the statuses (e.g., moving/stopped) of the objects, the speeds of the objects, the directions of movements of the objects, the widths and heights of the objects, and the types of the objects (e.g., a pedestrian, a vehicle or a motorcycle). The detection of objects present in the vicinity of the autonomous vehicle 30 may be performed by, for example, performing image recognition on the images captured by the camera of the ambient environment monitoring unit 33. In addition, in the case of the autonomous vehicle 30 being configured to acquire ambient data from infrastructure, other vehicles and networks via V2X communication, the object information may be obtained based also on the ambient data.

The assistance necessity determining unit 37 is configured to determine whether it is necessary for one of the operators to provide assistance to the autonomous vehicle 30. Specifically, when the autonomous vehicle 30 has fallen into a situation where it is difficult for the autonomous vehicle 30 to continue traveling, the assistance necessity determining unit 37 determines that assistance is needed. More particularly, in the present embodiment, when the autonomous vehicle 30 has been in a stopped state for a period of time longer than or equal to a predetermined threshold, the assistance necessity determining unit 37 determines that assistance is needed. It should be noted that the periods of time for which the autonomous vehicle 30 makes expected stops (e.g., when arriving at a destination, waiting a traffic light and waiting the getting on and off of passengers) are not taken into account in the assistance necessity determination.

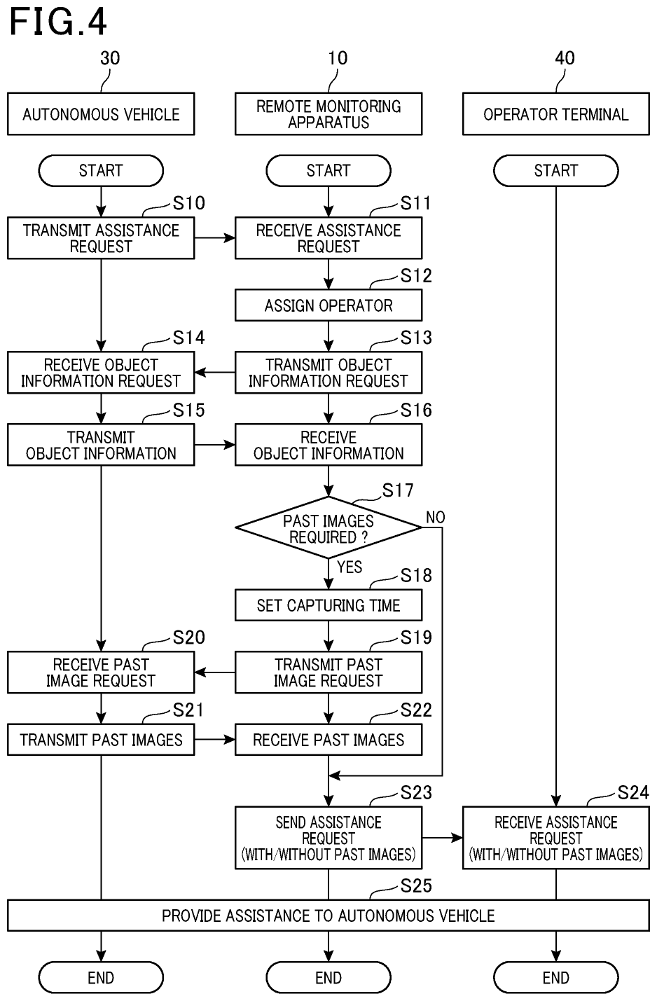

Next, operation of the remote monitoring system 1 according to the present embodiment will be described with reference to FIG. 4.

In step S10, an autonomous vehicle 30 transmits, upon determination that it needs assistance, an assistance request to the remote monitoring apparatus 10.

In step S11, the remote monitoring apparatus 10 receives the assistance request transmitted from the autonomous vehicle 30, and places (or stores) the received assistance request in the assistance request queue.

In step S12, the operator assignment unit 13 of the remote monitoring apparatus 10 retrieves the assistance request from the assistance request queue, and assigns an available operator to handle the assistance request. In addition, the operator assignment unit 13 may retrieve assistance requests in the order that the assistance requests are stored in the assistance request queue (i.e., FIFO (First-In, First-Out)) or according to the priorities of the assistance requests.

In step S13, the remote monitoring apparatus 10 transmits an object information request to the autonomous vehicle 30 which has transmitted the assistance request.

In step S14, the autonomous vehicle 30 receives the object information request transmitted from the remote monitoring apparatus 10.

In step S15, the autonomous vehicle 30 transmits to the remote monitoring apparatus 10 the object information at the time of receipt of the object information request.

In step S16, the remote monitoring apparatus 10 receives the object information transmitted from the autonomous vehicle 30.

In step S17, the remote monitoring apparatus 10 determines, based on the received object information, whether past images are required for determination of the current situation of the autonomous vehicle 30. In addition, as described above, when, for example, there is no moving object in the vicinity of the autonomous vehicle 30 and/or there is no traffic participant in the vicinity of the autonomous vehicle 30, the determining unit 15 determines that past images are required for determination of the current situation of the autonomous vehicle 30.

If the determination in step S17 results in a “NO” answer, i.e., if it is determined by the remote monitoring apparatus 10 that no past image is required, then the operation proceeds to step S23.

In step S23, the remote monitoring apparatus 10 sends the assistance request to the operator terminal 40 of the operator who is assigned to handle the assistance request. In other words, the remote monitoring apparatus 10 notifies the operator of the assistance request from the autonomous vehicle 30.

In step S24, the operator receives, via the operator terminal 40, the assistance request sent from the remote monitoring apparatus 10.

In step S25, the operator provides assistance to the autonomous vehicle 30. Specifically, the real-time images transmitted from the autonomous vehicle 30 are displayed by the operator terminal 40. While watching the real-time images, the operator determines the situation in which the autonomous vehicle 30 is currently placed and provides instructions to the autonomous vehicle 30 according to the determined situation.

On the other hand, if the determination in step S17 results in a “YES” answer, i.e., if it is determined by the remote monitoring apparatus 10 that past images are required, then the operation proceeds to step S18.

In step S18, the remote monitoring apparatus 10 sets a capturing time during which the required past images have been successively captured. More specifically, in the present embodiment, the determining unit 15 of the remote monitoring apparatus 10 sets the capturing time based on the object information.

In step S19, the remote monitoring apparatus 10 transmits a past image request to the autonomous vehicle 30.

In step S20, the autonomous vehicle 30 receives the past image request transmitted from the remote monitoring apparatus 10.

In step S21, the autonomous vehicle 30 transmits the past images captured during the set capturing time to the remote monitoring apparatus 10.

In step S22, the remote monitoring apparatus 10 receives the past images transmitted from the autonomous vehicle 30.

In step S23, the remote monitoring apparatus 10 sends the assistance request and the past images, both of which are received from the autonomous vehicle 30, to the operator terminal 40 of the operator who is assigned to handle the assistance request.

In step S24, the operator receives, via the operator terminal 40, both the assistance request and the past images sent from the remote monitoring apparatus 10.

In step S25, the operator provides assistance to the autonomous vehicle 30. Specifically, both the real-time images and the past images transmitted from the autonomous vehicle 30 are displayed by the operator terminal 40. While watching the real-time images and the past images, the operator determines the situation in which the autonomous vehicle 30 is currently placed and provides instructions to the autonomous vehicle 30 according to the determined situation.

In addition, in FIG. 4, operation of the remote monitoring system 1 is illustrated as being triggered by an assistance request from an autonomous vehicle 30. However, it should be noted that the remote monitoring apparatus 10 monitors a plurality of autonomous vehicles 30 and performs the process shown in FIG. 4 for each of the autonomous vehicles 30.

The remote monitoring apparatus 10 according to the present embodiment is configured with, for example, a computer which includes a CPU, a RAM, a ROM, a hard disk, a display, a keyboard, a mouse and communication interfaces. Moreover, the remote monitoring apparatus 10 has a program stored in the RAM or in the ROM; the program has modules for respectively realizing the functions of the above-described units 11-17 of the remote monitoring apparatus 10. That is, the remote monitoring apparatus 10 is realized by execution of the program by the CPU. In addition, it should be noted that the program is also included in the scope of the present disclosure.

As described above, in the present embodiment, the remote monitoring apparatus 10 determines whether past images are required for providing assistance to an autonomous vehicle 30 and requests past images from the automotive vehicle 30 only upon determination that the past images are required. Consequently, the remote monitoring apparatus 10 can suitably determine the current situation of the autonomous vehicle 30 with reference to past images as needed while suppressing the communications traffic.

Moreover, in the present embodiment, the remote monitoring apparatus 10 makes the determination as to whether past images are required before sending the assistance request from the autonomous vehicle 30 to the operator terminal 40 of the operator who is assigned to handle the assistance request. Further, upon determining that past images are required, the remote monitoring apparatus 10 acquires the past images from the autonomous vehicle 30 before sending the assistance request to the operator terminal 40. Consequently, it becomes possible to eliminate the time and effort for the operator to acquire the past images after the sending of the assistance request to the operator. As a result, it becomes possible for the operator to provide assistance to the autonomous vehicle 30 in a timely manner.

### Second Embodiment

A remote monitoring system 1 that includes a remote monitoring apparatus 10 according to the second embodiment has the same basic configuration as the remote monitoring system 1 that includes the remote monitoring apparatus 10 according to the first embodiment (see FIG. 1). Therefore, only the differences therebetween will be described hereinafter.

In the first embodiment, only the object information at the time of receipt of the object information request from the remote monitoring apparatus 10 by the autonomous vehicle 30 is used for the past image necessity determination.

In contrast, in the second embodiment, past object information is also used for the past image necessity determination. Here, the term “past object information” denotes object information earlier than the object information at the time of receipt of the object information request by the autonomous vehicle 30. More particularly, in the present embodiment, the past object information is object information at the time of transmission of the assistance request by the autonomous vehicle 30.

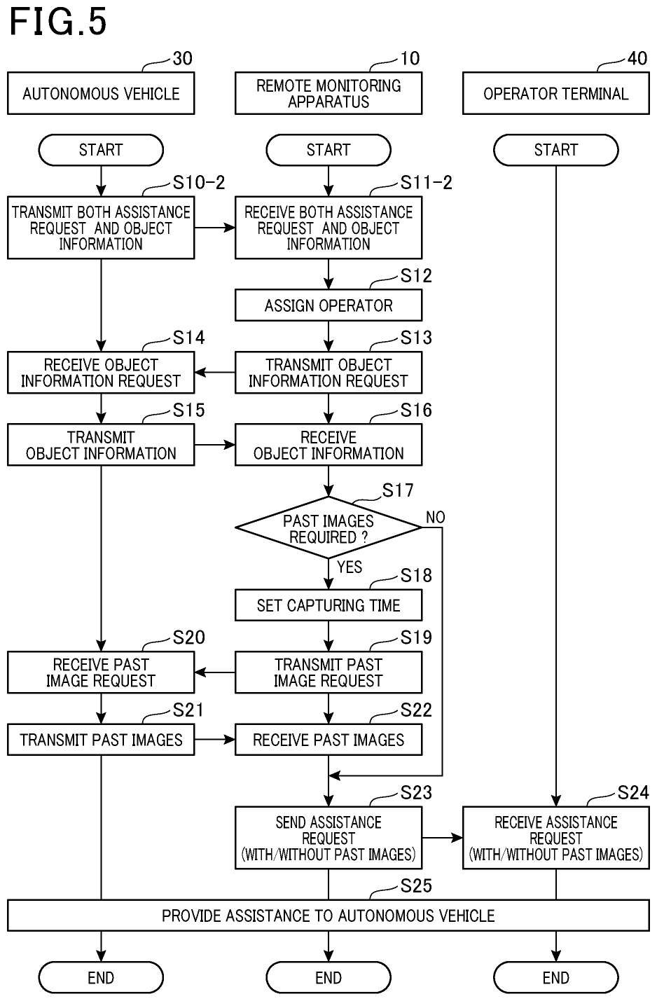

FIG. 5 illustrates operation of the remote monitoring system 1 according to the second embodiment.

In the second embodiment, in step S10-2, the autonomous vehicle 30 transmits, upon determination that it needs assistance, both the assistance request and the past object information to the remote monitoring apparatus 10.

In step S11-2, the remote monitoring apparatus 10 receives both the assistance request and the past object information transmitted from the autonomous vehicle 30, and places (or stores) the received assistance request in the assistance request queue.

In step S12, the operator assignment unit 13 of the remote monitoring apparatus 10 retrieves the assistance request from the assistance request queue, and assigns an available operator to handle the assistance request.

In step S13, the remote monitoring apparatus 10 transmits an object information request to the autonomous vehicle 30 which has transmitted the assistance request.

In step S14, the autonomous vehicle 30 receives the object information request transmitted from the remote monitoring apparatus 10.

In step S15, the autonomous vehicle 30 transmits to the remote monitoring apparatus 10 the object information at the time of receipt of the object information request.

In step S16, the remote monitoring apparatus 10 receives the object information transmitted from the autonomous vehicle 30. Consequently, the remote monitoring apparatus 10 has acquired both the object information at the time of transmission of the assistance request by the autonomous vehicle 30 (i.e., the object information received in step S11-2) and the object information at the time of receipt of the object information request from the remote monitoring apparatus 10 by the autonomous vehicle 30 (i.e., the object information received in step S16).

In step S17, the remote monitoring apparatus 10 determines, based on both the object information received in step S11-2 and the object information received in step S16, whether past images are required for determination of the current situation of the autonomous vehicle 30.

That is, in the present embodiment, the remote monitoring apparatus 10 makes the past image necessity determination based on comparison between the current object information (i.e., the object information received in step S16) and the past object information (i.e., the object information received in step S11-2). More specifically, when the current object information differs from the past object information, the remote monitoring apparatus 10 determines that past images are required for determination of the current situation of the autonomous vehicle 30.

In step S18, the remote monitoring apparatus 10 sets a capturing time during which the required past images have been successively captured.

More specifically, in the present embodiment, the determining unit 15 of the remote monitoring apparatus 10 sets the capturing time based on both the current object information and the past object information. In cases where the object that caused the autonomous vehicle 30 to be in the stopped state is not present in front of the autonomous vehicle 30 at the time of the operator assignment (e.g., as in the example shown in FIG. 3), the object might have been present in front of the autonomous vehicle 30 at the time of transmission of the assistance request by the autonomous vehicle 30. Therefore, the determining unit 15 may set, based on both the current object information and the past object information, the capturing time as a time period from when the object that caused the autonomous vehicle 30 to be in the stopped state was first recognized by the autonomous vehicle 30 to the present time. Otherwise, the determining unit 15 may set, based on both the current object information and the past object information, the capturing time as a time period from when the traveling speed of the autonomous vehicle 30 became lower than a predetermined speed to the present time.

Subsequent steps S19-S25 of the operation of the remote monitoring system 1 according to the second embodiment are identical to those of the operation of the remote monitoring system 1 according to the first embodiment. Therefore, description of steps S19-S25 is not repeated hereinafter.

The remote monitoring apparatus 10 according to the present embodiment has the same advantages as the remote monitoring apparatus 10 according to the first embodiment. That is, the remote monitoring apparatus 10 according to the present embodiment can also suitably determine the current situation of the autonomous vehicle 30 with reference to past images as needed while suppressing the communications traffic.

Moreover, the remote monitoring apparatus 10 according to the present embodiment can more suitably make the past image necessity determination and can more suitably set, based on both the current object information and the past object information transmitted from the autonomous vehicle 30, a capturing time during which the required past images have been successively captured.

While the above particular embodiments have been shown and described, it will be understood by those skilled in the art that various modifications, changes and improvements may be made without departing from the spirit of the present disclosure.

For example, in the above-described embodiments, the determining unit 15 of the remote monitoring apparatus 10 is configured to set a capturing time during which the required past images have been successively captured based on the object information. As an alternative, the determining unit 15 may be configured to set a capturing direction in which the required past images have been captured. For example, when a detected object has moved away from the front to the left side of the autonomous vehicle 30, past images captured along the direction from the front to the left side of the autonomous vehicle 30 may be required for determination of the current situation of the autonomous vehicle 30. Therefore, in this case, the determining unit 15 may set the capturing direction as the direction from the front to the left side of the autonomous vehicle 30. Moreover, in the case of the autonomous vehicle 30 having a plurality of cameras configured to capture images in different directions, it is possible to transmit to the remote monitoring apparatus 10 only those past images which have been captured by one of the cameras in the set capturing direction, thereby minimizing the amount of image data transmitted from the autonomous vehicle 30 to the remote monitoring apparatus 10.

In the above-described embodiments, a plurality of past images which have been successively captured during the set capturing time are used for determination of the current situation of the autonomous vehicle 30. However, depending on the current situation of the autonomous vehicle 30, only one past image may be used for determination thereof.

Each of the remote monitoring apparatuses 10 according to the above-described embodiments may also be applied to cases where an assistance request is transmitted from an autonomous vehicle 30 to the remote monitoring apparatus 10 due to the occurrence of a vehicle failure or an accident. Moreover, in the case of an assistance request being transmitted from an autonomous vehicle 30 to the remote monitoring apparatus 10 due to the occurrence of an accident, the determining unit 15 of the remote monitoring apparatus 10 may set the capturing time as a time period from when the impact due to the accident was first recognized by the autonomous vehicle 30 to the present time.

Each of the remote monitoring apparatuses 10 according to the above-described embodiments may also be applied to cases where an assistance request is transmitted from an autonomous vehicle 30 to the remote monitoring apparatus 10 due to the occurrence of an abnormal event in the passenger compartment of the autonomous vehicle 30. For example, upon detecting something left in the passenger compartment or a sick passenger, the autonomous vehicle 30 may transmit an assistance request to the remote monitoring apparatus 10. Moreover, in the case of the assistance request being transmitted from the autonomous vehicle 30 to the remote monitoring apparatus 10 due to something left in the passenger compartment, the determining unit 15 of the remote monitoring apparatus 10 may set the capturing time as a time period during which passengers get on and/or off the autonomous vehicle 30. Consequently, it will become possible to identify the passenger who left something in the passenger compartment. Furthermore, in the case of the autonomous vehicle 30 being an autonomous taxi, it may be possible for the remote monitoring apparatus 10 to notify, via a user terminal of the passenger used when booking the taxi, the passenger that he (or she) has left something in the taxi.

Each of the remote monitoring apparatuses 10 according to the above-described embodiments may also be applied to cases where an assistance request is transmitted from an autonomous vehicle 30 to the remote monitoring apparatus 10 in response to a passenger's request. For example, the autonomous vehicle 30 may transmit an assistance request to the remote monitoring apparatus 10 when there is a sick passenger, an inquiry from a passenger or a vehicle abnormality warning. Moreover, in the case of the assistance request being transmitted from the autonomous vehicle 30 to the remote monitoring apparatus 10 due to the falling over of a passenger, the determining unit 15 of the remote monitoring apparatus 10 may set the capturing time as a time period during which the cause of the falling over (e.g., sudden braking) happened. Otherwise, in the case of the assistance request being transmitted from the autonomous vehicle 30 to the remote monitoring apparatus 10 in response to an inquiry from a passenger, the determining unit 15 of the remote monitoring apparatus 10 may set the capturing time based on conversation between the passenger and the operator who is assigned to handle the assistance request, and acquire the past images captured during the set capturing time from the autonomous vehicle 30.

In the above-described embodiments, each of the autonomous vehicles 30 is configured to transmit past images to the remote monitoring apparatus 10 upon receipt of a past image request from the remote monitoring apparatus 10. However, each of the autonomous vehicles 30 may alternatively be configured to ignore the past image request when there is no additional information obtainable from past images. For example, when the front-side situation of the autonomous vehicle 30 cannot be determined based only on the real-time images and thus a past image request is transmitted from the remote monitoring apparatus 10 to the autonomous vehicle 30, if the autonomous vehicle 30 is traveling on a flat and straight road, it will still be impossible to determine the front-side situation of the autonomous vehicle 30 based even on past images. Therefore, in this case, the autonomous vehicle 30 may ignore the past image request from the remote monitoring apparatus 10. Moreover, when the cause of stopping of the autonomous vehicle 30 is not reflected in past images, the autonomous vehicle 30 may ignore the past image request from the remote monitoring apparatus 10.

What is claimed is:

1. A remote monitoring apparatus for monitoring an autonomous vehicle via remote communication with the autonomous vehicle, the remote monitoring apparatus comprising:
an assistance request receiving unit configured to receive an assistance request transmitted from the autonomous vehicle;
an object information receiving unit configured to request, before the assistance request received by the assistance request receiving unit is sent to an operator, the autonomous vehicle to transmit object information on an object in the vicinity of the autonomous vehicle and receive the object information transmitted from the autonomous vehicle;
a determining unit configured to determine, based on the object information received by the object information receiving unit, whether at least one past image captured by the autonomous vehicle is required;
a past image receiving unit configured to request, in response to determination by the determining unit that at least one past image captured by the autonomous vehicle is required, the autonomous vehicle to transmit the at least one past image and receive the at least one past image transmitted from the autonomous vehicle; and
an operator collaboration unit configured to send, in response to receipt of the at least one past image by the past image receiving unit, the at least one past image along with the assistance request received by the assistance request receiving unit to the operator, thereby initiating collaboration with the operator.

2. The remote monitoring apparatus as set forth in claim 1, wherein the determining unit is configured to further set a capturing time based on the object information, and
the past image receiving unit is configured to request the autonomous vehicle to transmit a plurality of past images, which have been successively captured as the at least one past image during the capturing time set by the determining unit, and receive the plurality of past images transmitted from the autonomous vehicle.

3. The remote monitoring apparatus as set forth in claim 1, wherein the determining unit is configured to further set a capturing direction based on the object information, and
the past image receiving unit is configured to request the autonomous vehicle to transmit the at least one past image, which has been captured in the capturing direction set by the determining unit, and receive the at least one past image transmitted from the autonomous vehicle.

4. The remote monitoring apparatus as set forth in claim 1, wherein the assistance request receiving unit is also configured to receive object information that is transmitted along with the assistance request from the autonomous vehicle, the object information received by the assistance request receiving unit being information on an object in the vicinity of the autonomous vehicle at the time of transmission of the assistance request by the autonomous vehicle, and
the determining unit is configured to determine, based on both the object information received along with the assistance request by the assistance request receiving unit and the object information received by the object information receiving unit, whether at least one past image captured by the autonomous vehicle is required.

5. The remote monitoring apparatus as set forth in claim 1, further comprising an operator assignment unit configured to assign the operator to handle the assistance request transmitted from the autonomous vehicle,
wherein the object information receiving unit is configured to request, in response to the assignment of the operator by the operator assignment unit, the autonomous vehicle to transmit the object information and receive the object information transmitted from the autonomous vehicle.

6. A method of assisting an autonomous vehicle in a remote monitoring system, the remote monitoring system including the autonomous vehicle and a remote monitoring apparatus configured to monitor the autonomous vehicle via remote communication with the autonomous vehicle,
the method comprising:
an assistance request transmitting step in which the autonomous vehicle transmits an assistance request to the remote monitoring apparatus;
an object information request transmitting step in which the remote monitoring apparatus transmits, upon receipt of the assistance request transmitted from the autonomous vehicle, an object information request to the autonomous vehicle;
an object information transmitting step in which the autonomous vehicle transmits, in response to the object information request from the remote monitoring apparatus, object information to the remote monitoring apparatus, the object information being information on an object in the vicinity of the autonomous vehicle;
a determining step in which the remote monitoring apparatus determines, based on the object information transmitted from the autonomous vehicle, whether at least one past image captured by the autonomous vehicle is required;
a past image request transmitting step in which the remote monitoring apparatus transmits, upon determining that at least one past image captured by the autonomous vehicle is required, a past image request to the autonomous vehicle;
a past image transmitting step in which the autonomous vehicle transmits, in response to the past image request from the remote monitoring apparatus, at least one past image captured by the autonomous vehicle to the remote monitoring apparatus; and
an assistance request notifying step in which the remote monitoring apparatus notifies an operator of the assistance request from the autonomous vehicle,
wherein
upon receipt of the at least one past image transmitted from the autonomous vehicle, the remote monitoring apparatus sends, in the assistance request notifying step, the at least one past image along with the assistance request to the operator.

7. The method as set forth in claim 6, further comprising, after the determining step and before the past image request transmitting step, a capturing time setting step in which the remote monitoring apparatus sets a capturing time based on the object information,
wherein in the past image transmitting step, the autonomous vehicle transmits, in response to the past image request from the remote monitoring apparatus, a plurality of past images which have been successively captured as the at least one past image during the capturing time set in the capturing time setting step.

8. The method as set forth in claim 6, further comprising, after the determining step and before the past image request transmitting step, a capturing direction setting step in which the remote monitoring apparatus sets a capturing direction based on the object information,
wherein in the past image transmitting step, the autonomous vehicle transmits, in response to the past image request from the remote monitoring apparatus, the at least one past image which has been captured in the capturing direction set in the capturing direction setting step.

9. The method as set forth in claim 6, wherein in the assistance request transmitting step, the autonomous vehicle also transmits object information along with the assistance request to the remote monitoring apparatus, the object information being information on an object in the vicinity of the autonomous vehicle at the time of transmission of the assistance request by the autonomous vehicle, and
in the determining step, the remote monitoring apparatus determines, based on both the object information transmitted by the autonomous vehicle in the assistance request transmitting step and the object information transmitted by the autonomous vehicle in the object information transmitting step, whether at least one past image captured by the autonomous vehicle is required.

10. The method as set forth in claim 6, further comprising, after the assistance request transmitting step and before the object information request transmitting step, an operator assigning step in which the remote monitoring apparatus assigns, upon receipt of the assistance request transmitted from the autonomous vehicle, the operator to handle the assistance request.
